(19) United States
(12) Patent Application Publication
(10) Pub. No.: US 2024/0359309 A1
(43) Pub. Date: Oct. 31, 2024

(54) Dynamically Adjustable Tool Holder

(71) Applicants: Daniel R Luke, Portland, OR (US); Evan J Homan, Portland, AL (US)

(72) Inventors: Daniel R Luke, Portland, OR (US); Evan J Homan, Portland, AL (US)

(21) Appl. No.: 18/764,095

(22) Filed: Jul. 3, 2024

Related U.S. Application Data
(60) Provisional application No. 63/524,931, filed on Jul. 5, 2023.

(51) Int. Cl. B25G 3/38

(52) U.S. Cl. CPC B25G 3/38

(57) ABSTRACT

An adjustable tool holder that allows releasable mounting of various tool heads like brooms, rakes, shovels, and many others. The tool head angle can be adjusted in two ways: 1) the tool head, with respect to the handle, (supposing the handle is perpendicular to the ground) can be angled dynamically, in a sweeping arc of 270°, with a plurality of locking positions along this are, without interrupting use. This enables the user to instantly adapt the tool orientation for improved ergonomics and access. The dynamic adjustment eliminates the need to pause work to reconfigure the tool, increasing efficiency; 2) The tool head can also be mounted around its axis in approximately 45° increments of 360°.

This application claims the benefits of U.S. Provisional Application No. 63/524,931, filed on Jul. 5, 2023.

### BACKGROUND OF THE INVENTION

### Field of the Invention

The present invention relates to an adjustable tool holder, specifically a tool holder which features a mechanism for securely attaching a tool head to a handle, allowing for adjustable orientation and ergonomic use.

### Description of Related Art

Tool holders which are both dynamically adjustable, and modular are known, but are typically limited to shovels, and forks even though these two characteristics are useful for a much broader range of tools including brooms, rakes, squeegees, paint rollers, scraping and pry tools and more.

Problems with Existing Solutions

Dynamic, modular tool holders are known. EP1569077A1 teaches a releasably coupled adapter that allows a limited rotation of the tool's head with respect to the tool's handle. The coupling means consists of an adapter with two threaded male ends to which the female ends of both a handle, and tool head can be releasably coupled. Yet, a threaded connection will not stay tightly coupled when expected torsional forces are applied against the tightened bias of the screw threads, and there is no means disclosed to prevent loosening thereof. Additionally, the need to screw tools on or off would be time consuming given that it would take at least several seconds to perform this operation under even ideal conditions.

EP1569077A1 does not teach a means by which to securely couple tool heads and handle at 45° increments which limits the tool heads effectiveness. EPI569077A1 also does not teach a separation of concerns between the handle, the rod that is inside the handle, and the hinge around which the rod (and therefore handle) pivots and locks into one of three apertures. Because it is the rod which must engage the hinge, it must necessarily be stout enough to resist the forces that will be applied against it. As a result, this rod, given that it is continuous from that point at which it engages the socket portion all the way up almost the entire length of the handle, it would necessarily be heavy, and this extra weight would lead to user fatigue and higher cost. Lastly, because the actuating rod in EPI569077A1 issues directly from handle to hinge, the handle constrains the width of the end of the rod resulting in limited contact surface between the rod and the hinge mechanism.

U.S. Pat. No. 1,690,189A teaches an adjustable shovel, but not one which is modular, and not one that allows the tool head to rotate axially in increments of 45°. Further, it teaches an adjustable shovel which uses a rod situated on top of the main handle as part of the adjustable mechanism.

An external actuating rod introduces two further disadvantages: 1) outwardly situated, the actuating rod is exposed to the various destructive and violent forces which shovels and similar tools are exposed as they are designed, themselves, to inflict on the materials they are meant to manipulate, thus making the actuating rod more susceptible to sustain damage, 2) the actuating mechanism would tend to interfere with the natural and comfortable placement of the user's hands; 3) the actuating rod could not be practically activated with only one hand without interrupting the flow of work; 4) because the actuating rod is not housed within a structure, it is unreinforced by the additional bracing that a housing would furnish.

U.S. Pat. No. 6,316,541B1 teaches another adjustable shovel which does not incorporate a modular design, nor, like the other instances of prior art cited, a tool head which can be axially rotated in 45° increments. Further, U.S. Pat. No. 6,316,541B1 does not appear to be a workable design. For instance, it is not clear either by illustration or verbal description, how the pawl holds the position of the shovel head, or how, if it is able to hold the position of the shovel head, the pawl can be urged out of the gear teeth within which it supposed to be lodged to permit the angling of the handle to another position correspondent to a different set of gear teeth.

U.S. Pat. No. 7,293,317B2 teaches a tool holder which can be angled by means of a gear-like structure around which the handle rotates, but does not incorporate a modular design wherein a tool head can be releasably mounted. Therefore, the tool head cannot be angled in increments of 45° in addition to the angling of the handle, and the tool cannot be used with more than one tool head attachment. The ‘locking projection” is also constrained by the width of the handle which puts a hard limit on the amount of surface area available for the “locking projection” to index to the part which it is meant to hold in position.

### Objectives of the Invention

The present invention aims to address these issues, first by using a third, intermediate component, the joint, to separate the handle from the assembly where the mounting of a tool head takes place. With this approach, it is possible to move almost all of the hardware needed to achieve the mounting of the tool head, along with dynamic adjustment, to the handle. If each tool head required complex its own mounting and rotational locking hardware, costs would rise. Therefore, in a modular system like the present invention, it is paramount to contain the complexity within the tool holder to keep the cost of each tool head as low as possible. Owing to joint 75, each tool head needs only a simple octagonally-shaped adapter 6, and that adapter indexes to the mounting, locking/unlocking, and rotating elements on or within the tool holder.

More importantly, by using a joint 75 as an intermediate component between the handle 96 and tool head, the width of the mechanism and its associated parts, that permit or block the rotation of the tool head is not constrained by the width to the handle's lumen as in instances of prior art that locate a rod within the handle's lumen 97, and then use that very same rod to index a locking mechanism, or that use a pawl to index a locking mechanism by way of a rod.

In the present invention, a cable 66, instead of a rod, is used, and this cable 66 serves a single purpose: a means by which to retract the brake foot 68 which then permits the rotation of the tool head with respect to the tool holder's handle 96. Thus, resistance applied to the locking mechanism is not applied against cable 66.

Because of the use of joint 75 as a third component between handle 96 and tool head, the width of the locking mechanism in the present invention—the brake foot 68—is in no way constrained by the width of the handle's lumen 97. As a result, the width of the brake foot 68 can be much broader than in any other examples of extant prior art which means that it can offer much greater resistance against rotation when it is engaged. Further, because the brake foot 68 is securely and conformally housed within the joint 75, the inner walls of the joint, or, more formally, the walls of the octagonal tool adapter chamber, abutting the surface contours of the brake foot 68, serve as additional resistance against rotation.

The mounting mechanism, corresponding to the “drum assembly” 16 in the present application, has an interior chamber 17, and this chamber 17 is octagonal in geometry. It receives an octagonal adapter 6 attached to each tool head which can be mounted at one of eight stations of rotation, with each station representing a 45° difference from the adjacent stations. This means that, by means of the handle 96, each tool head can be pushed forward or pulled back at an angled bias with respect to the surface it is being pushed or pulled against, much like a snow plow, having a similar bias, is able to move in a straight line, but nevertheless push material to one side and thus over and away from the road bed.

On the outside surface of the drum assembly 16, there are a plurality of slots 21-27 which the tooth of the brake foot b engages. The width of this drum assembly 16, owing to the joint 75 separating the handle 96 from the tool head, is therefore unconstrained by the width of the handle 96 which means it can be broader than would otherwise be the case.

Within drum assembly 16, there is a spring biased tool lock 49 which has an aperture 57, octagonally shaped. When the octagonal adapter 6 of the tool head is being mounted, it passes through the octagonal aperture of the tool lock 57, against the bias of the springs 31,32 to the point at which a notch in the adapter 12 is coplanar with the tool lock 49, at which point, the tool lock 49 with, as opposed to against, the bias of the springs 31,32 slides under the notch 12 and then locks the tool head in place. The design of chamber 17, adapter 6, and tool lock 49 make it possible to mount a tool head by being pushed into the drum assembly's 16 chamber 17, making tool change outs fast and seamless.

The handle 96 of the tool holder is mounted within joint 75 and secured by a plurality of screws 89,90. Additionally, a joint compression collar 93 can be screwed down onto the top portion of the joint 75 which has a plurality of flanges 92. When the compression collar 93 is screwed down, it compresses the flanges 92 on the joint 75 against the outer surface of the handle 96. The effect of the compression collar 93 is to augment and reinforce the fit of the handle 96 within the joint 75, and to ensure that the screws 89,90 which also serve this purpose, do not become loosened over time. The belled-out geometry of the distal end of the compression collar 94 forms a circumferential ridge over the accessory mounting dock 76 of the joint 75 which makes it possible to secure an accessory like a secondary handle 82 on the joint's 75 accessory mounting dock 76. This dock 76 is complementary to the magnetized dock 113 at the proximal end of the tool holder 1 which is intended to secure the proximal end of a secondary handle 82, or another kind of accessory like a dustpan.

In use, this tool offers many advantages over the prior art. First, because the brake foot 68 is not connected by a rod, but by a cable 66, a considerable amount of weight, and therefore cost is saved (heavier items tend to cost more by themselves, and they also cost more to ship). By using a cable 66 instead of a rod, lighter tools are also easier to maneuver which is an important consideration when it comes to lighter tools like brooms, rakes, squeegees, and a broad assortment of other tools.

The octagonal tool adapter 6 along with the octagonal tool adapter chamber 17 of the drum assembly 16 means that it is possible to mount a tool to the tool holder 1 at one of eight stations, with each station corresponding to a 45° difference from adjacent stations. This means that tools can be mounted at a slant, and this offers immediate, and practical advantages such as when using a squeegee 5 or a snow shovel where it might be advantageous to be able to push the tool holder 1 with coupled tool head forward in a straight line, while the angled tool head is able to push material to one side or the other.

Owing to the dynamic adjustability of the tool holder 1, all coupled tools can self-stand. This saves time and adds to convenience. This is an important consideration on many job sites as the alternatives would be to lean the tool against a surface, or to lay it on the floor. The first option often takes extra time as one needs to search for a suitable place to lean a tool. It also gets in the way of the object and space of the thing it is leaned against, a counter or trash can, for example, that might subsequently need to be used by someone else who then needs to move the tool again to somewhere else. Laying a tool on the floor requires bending at one's back to both lay it down, and to pick it up later when it needs to be used again. It can also cause a tripping hazard.

While doing yardwork or landscaping the ability for a tool to self-stand is particularly advantageous as one tends to switch back and forth frequently from one tool to the next. Repeatedly having to bend down to leave a tool on the ground takes extra time and energy and puts a strain on one's back. Often there is no convenient place to lean a tool against some other object.

The ability to adjust and angle the tool head of the tool holder 1 dynamically means that one does not have to interrupt one's work to make the adjustment which adds greatly to convenience, and time-savings. But it's the added capabilities that dynamic adjustment adds which matters equally. Self-standing in only one. Another is to be able to angle a broom head 2 so that it can clean the tops of surfaces that would otherwise be very difficult or impossible to reach without a ladder or some other device to reach an elevated surface. The broom can be angled to clean the tops of ceiling fan blades, molding, and high-up ledges from a standing position on the floor. This not only adds to convenience, but also safety.

The rake 4 can be used not only for its primary and original purpose—to rake leaves into a pile—but also, owing to the dynamic tool adjustment, to pick up leaves. The handle 96 can be angled over the rake tool head 4 at a greater-than −45° angle, which means that the material that it is able to pick up does not need to be carefully balanced to avoid spillage. It also means that the when the load needs to be discharged, it's close to the body's centerline mass which makes this task much easier than it otherwise would be, and is, with all other tools, which require the body to act as a cantilever when discharging a load off of, say, a shovel.

And there are still more possibilities, for instance as a prying tool. Though the present invention does not disclose a ratchet, the action of the locking mechanism and the drum can act like a ratchet. If one of the tool heads were meant for prying up flooring, one could slide the head of the tool under the flooring, and then adjust and lock the handle forward, saving the worker the trouble of having to push the tool's handle downward which would also usually necessitate having to bend.

### SUMMARY OF THE INVENTION

The present invention is an adjustable, modular tool holder featuring a unique dynamic handle and easy, tool head mounting system that overcomes limitations of prior art designs. A “push-in,” secure mounting mechanism allows tool heads like brooms, rakes, and shovels to be easily attached and detached at one of eight pre-set 45° increments via an octagonal adapter interface. “Push-in” in this context means that the sliding lock that holds and releases the tool head is, by virtue of being mounted, is unlocked and locked automatically which makes mounting the tool head easier than it otherwise would be if it were necessary for the user to manipulate some mechanism to achieve an unlock state, or to, once achieved, create a locked state.

To mount, the tool head's octagonal adapter is simply rotated to the desired angle increment and coupled to the handle's corresponding receptor-providing a secure, locked connection. This innovative mounting allows reliable tool head positioning without cross-threading or complex attachments.

Once mounted at a fixed angle, true dynamic flexibility occurs through the ability to then change the orientation between the locked tool head and handle itself using a press-button adjustment. This dynamic articulation can alter the angle seamlessly while in use without interrupting work.

Importantly, after adjusting to a new desired angle, the handle mechanism locks in place until the next change-eliminating instability or unintended movement. This secure, dynamic articulation allows unrestricted optimization of the tool orientation from any starting angle.

For example, the combination of multi-angle mounting, and dynamic locked articulation enables positioning of a broom with inverted bristles to effectively clean surfaces like shelving or ceilings that non-dynamic brooms cannot properly access. This novel system empowers tackling tasks ergonomically that rigid tools cannot.

The tool holder's dynamic adjustability, secure tool head interface, modular versatility, and efficient angle adaptability for each job provide significant advantages over conventional tools and previous adjustable models.

### BRIEF DESCRIPTION OF THE DRAWINGS

FIG. 1 is a view of the tool holder.

FIGS. 2-3 is a view of the proximal end of tool holder (FIG. 2) and distal end of tool holder (FIG. 3)

FIGS. 4-7 is a section view showing mechanism of tool head rotation, in relation to tool holder's handle, including button press/release and drum lock/unlock cycles.

FIGS. 8-11 are cutaway views showing how locking mechanism stops and permits rotation.

FIGS. 12-16 are cutaway views showing how tool lock locks tool head adapter in place.

FIGS. 17-19 views showing that each tool head can be mounted in degree increments of 45°.

FIGS. 20-22 views showing the advantages of being able to angle handle in relationship to tool head for broom. It also shows a self-standing push broom with a secondary handle attached to the tool holders accessory tool dock.

FIGS. 23-26 views showing the advantages of being able to angle handle in relationship to tool head for rake.

FIG. 27 views showing the advantages of being able to angle handle in relationship to tool head for a squeegee.

FIG. 28 view showing how octagonally shaped adapter can fit into drum assembly.

FIG. 29-FIG. 30 FIG. 29 is a callout view of the assembly shown in FIG. 30. FIG. 30 is a view showing how threaded compression collar is screwed down on the joint to stabilize and secure the handle within the joint, while also creating a surface for the attachment of a secondary handle.

FIG. 31 is a callout view of the proximal handle assembly shown in FIG. 32.

FIG. 32 is an exploded view of the proximal handle.

FIG. 33 is a callout view of FIG. 34 which is an exploded view of the distal portion of the handle assembly.

FIG. 35 is an exploded view of drum assembly.

FIG. 36 is a detailed view of the inner surface of the tool lock key.

FIG. 37 is an exploded view of the joint, including the drum assembly.

FIG. 38 view showing the threads of the threaded joint compression collar.

FIG. 39 exploded view showing the spring wells, cable lumen and springs of the brake foot assembly.

### DETAILED DESCRIPTION OF THE INVENTION

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used as a tool holder, capable of holding a broad variety of tools and their variations. Some examples include a broom, a rake, a shovel, a paint roller, a squeegee, and more. The examples given should not be construed as anything other than a partial list of applications, with the possible embodiments spanning a much wider breadth.

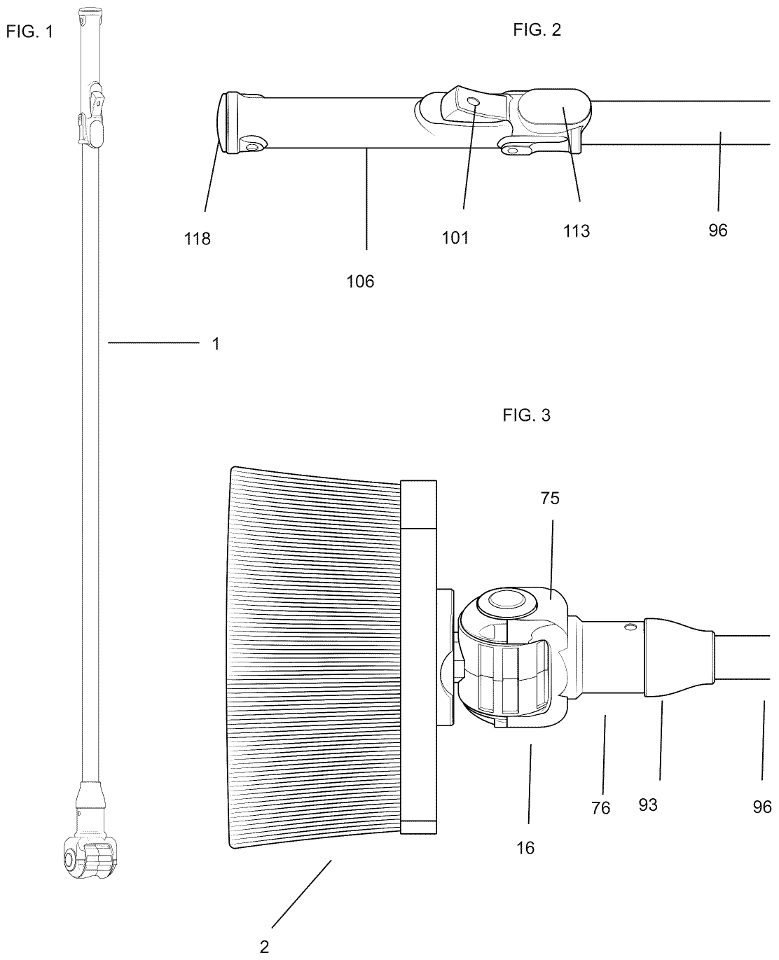

FIG. 1 shows an external, fully assembled view of tool holder 1, having a proximal end FIG. 2, and a distal end FIG. 3. In this document, the word “proximal” is used to mean “toward the proximal end of tool holder 1” as shown in FIG. 2, and “distal” is used to mean “toward the distal end of tool holder 1 as shown in FIG. 3. FIG. 2 shows handle 96; the handle casing 106; toggle 101; end cap 118; and magnetic accessory dock 113. FIG. 3 shows the handle 96; the joint 75; the secondary handle accessory dock 76; the drum assembly 16; the compression collar 93; and a mounted broom tool head 2.

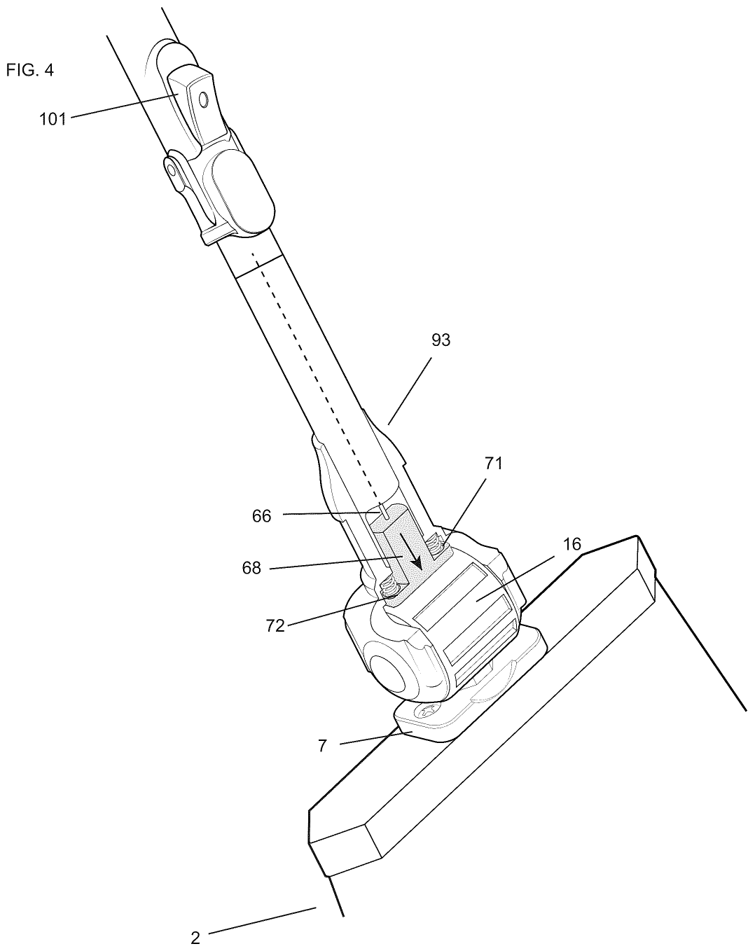

FIGS. 4-7 are cutaway views between outer surface of drum assembly 16 and proximal end of compression collar 93. The inner surface 95 of compression collar 93 is threaded 95 as shown in FIG. 43. Each view in this series FIGS. 4-7 shows a step in the entire cycle of drum assembly 16, and thereby, tool head 2-5 rotation with respect to handle 96. The view of the handle 96 in FIGS. 4-7 is truncated.

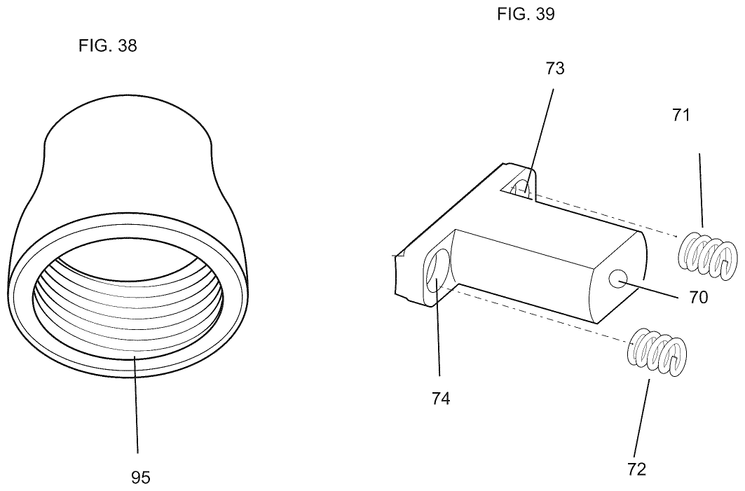

FIG. 4 depicts tool holder 1 in a stable, locked state: toggle 101 connects brake foot 68 via cable 66 that runs through handle lumen 97, and through the brake foot cable lumen 70. Refer to FIG. 37 for a detailed, exploded view that describes how cable 66 connects to toggle 101. In this state, the brake foot tooth 69 of the brake foot 68 is secured via the urging force of springs 71, 72 into drum slot 24 of drum assembly 16. The brake foot tooth 69, so stationed into slot 24 of drum assembly 16, prevents the tool head adapter 6, and thus the tool head 2-5 to which adapter 6 is attached via tool head adapter screws 14, and 15, from rotating. In such state, tool holder 1 can be maintained securely and indefinitely at a consistent angle in relation to tool heads 2-5 until such time that toggle 101 is depressed.

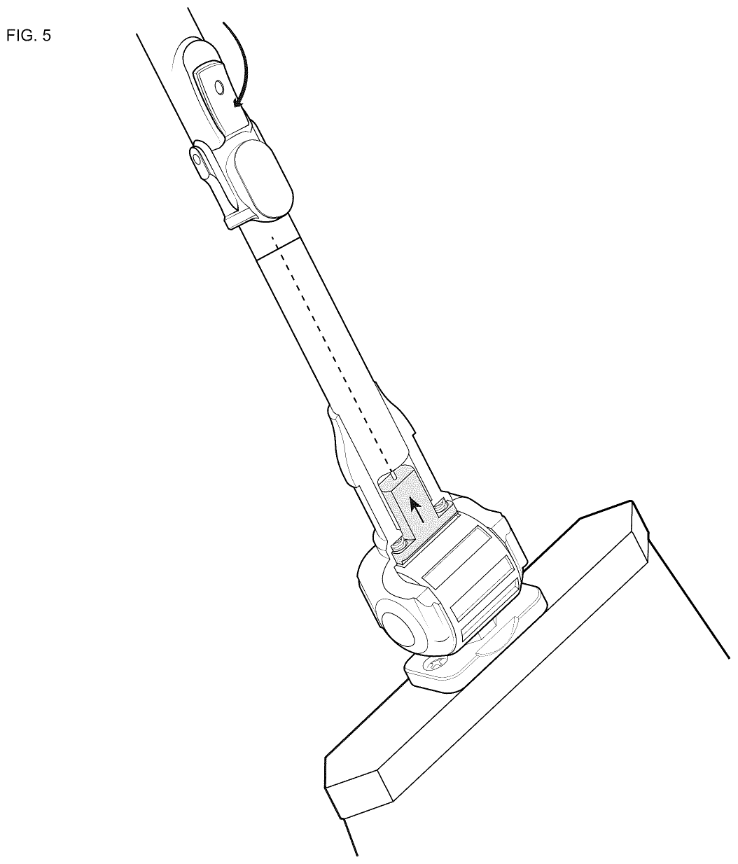

FIG. 5 depicts tool holder 1 in a state in which rotation of drum assembly 16 and any attached tool 2-5 is possible but has not yet begun. This view shows that toggle 101 is depressed. Cable 66 runs through lumen 97 of handle 96, and through the brake foot cable lumen 70. At its distal end, cable 66 terminates in a brake foot cable stop 67, the diameter of which is larger than brake foot cable lumen 70.

When force is applied against toggle 101 in its direction of travel, that being inward and toward the handle toggle aperture 100, the force is transferred to cable 66, then to the brake foot cable stop 67, and then to brake foot 68. The force applied against toggle 101, when applied in sufficient quantity to overcome the compression force of the brake foot springs 71, 72, (secured in wells 73,74 to prevent unwanted travel as shown in FIG. 44) results in the movement of the brake foot 68 along with the brake foot tooth 69 away from and out of slot 24 into which it was previously situated.

FIG. 6, via an arc movement arrow, shows the movement of the rotation of drum assembly 16; adapter 6; and broom tool head 2 which is made possible when toggle 101 is depressed for a duration equal to the amount of time that it takes to perform the rotation. An arc movement arrow is also used to show that toggle 101 is in a depressed state during the rotation herein described, while an upwardly pointing linear movement arrow shows the movement of the brake foot 68. In this illustration, the brake foot 68 along with the brake foot tooth 69 is being disengaged from drum slot 24.

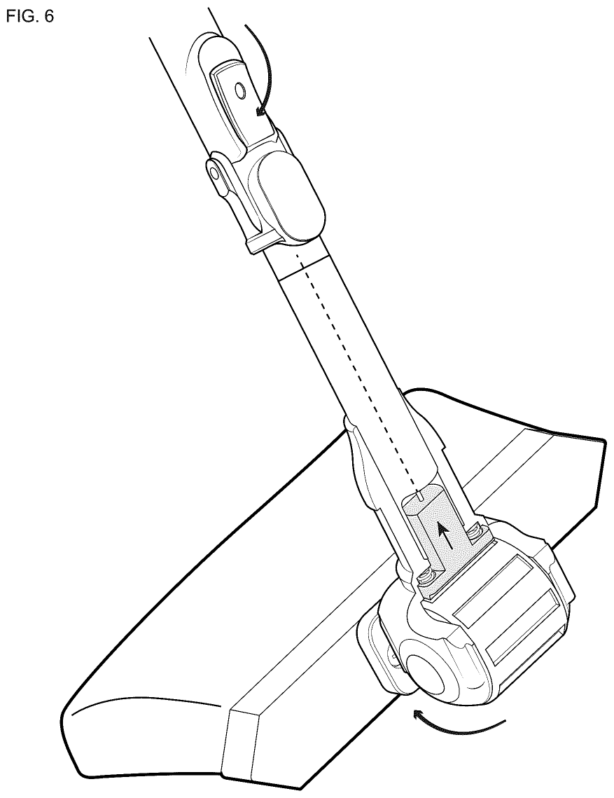

FIG. 7 shows tool holder 1 in a new stable state with tool adapter 6; drum assembly 16; and broom tool head 2 rotated 90°, and brake foot tooth 69 locked into drum assembly 16 slot 2 as shown by directional arrow. An arc movement arrow is used to show that toggle 101 is no longer depressed. As a result, the urging force of brake foot springs 71,72 urge brake foot 69 and brake foot tooth 69 into drum assembly 16 slot 26.

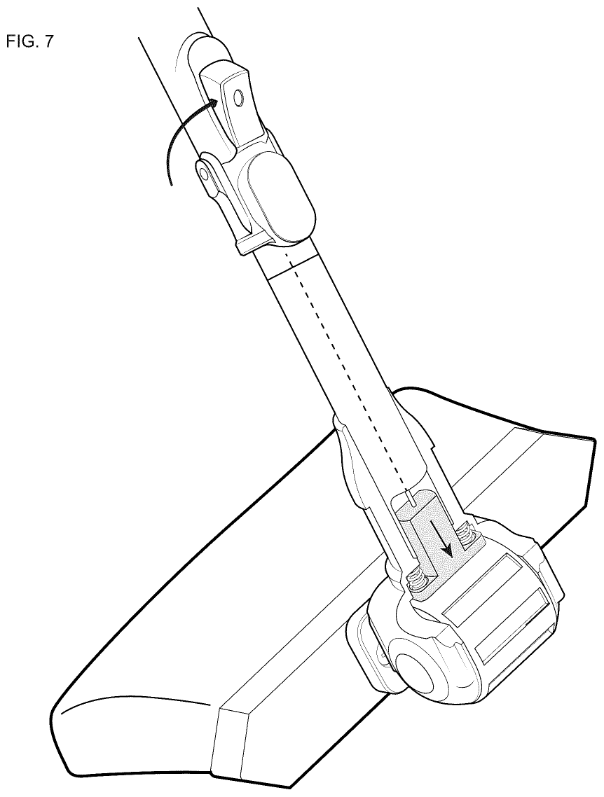

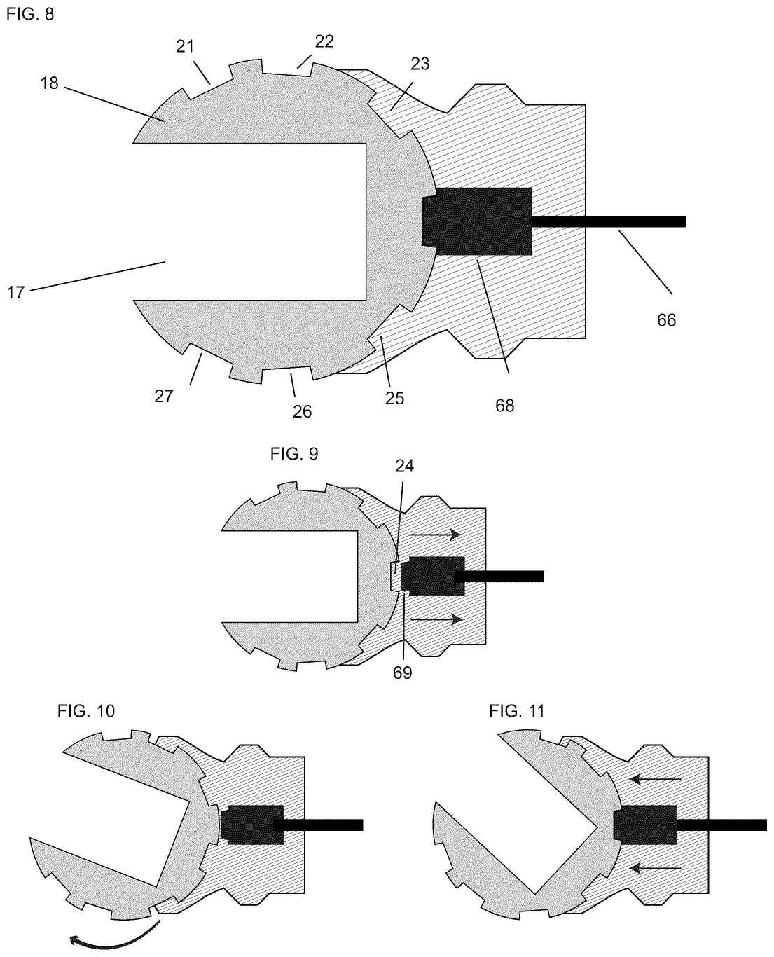

FIGS. 8-11 are cutaway views of drum assembly 16 and joint 75. As such, these views are intended to complement FIGS. 4-7 by showing more explicitly how the geometry of the brake foot tooth 69 indexes to drum assembly 16 slots 21-27 to either permit or prevent the rotation of handle 96 around drum assembly 16 depending on whether brake foot tooth 69 is engaged into one of the drum slots 21-27 of the drum assembly 16. It is also intended to depict the entire cycle of lock, unlock, rotation, and re-lock. This cycle is an interplay between toggle 101, cable 66, brake foot 68, brake foot tooth 69, drum assembly 16, and drum slots 21-27, illustrated by FIGS. 4-11, and accompanying text.

FIG. 8 depicts a locked state with the brake foot tooth 69 engaged in drum slot 24. While brake foot tooth 69 is so engaged, rotation of drum assembly 16 is locked.

FIG. 9 depicts an unlock state with the brake foot tooth 69 disengaged from drum slot 24. Tool head 2-5 is now in a ready state for rotation.

FIG. 10 depicts, via an arc movement arrow, the state of rotational movement of drum assembly 16. This state is shown to be achievable because the brake foot tooth 69 has retreated from drum slot 24 by a distance that allows clearance of the brake foot tooth 69 from the drum slot 24 of drum assembly 16.

FIG. 11 depicts drum assembly 16 has been rotated from one drum slot 24 shown in FIG. 8, to an adjacent drum slot 23. The brake foot tooth 69 is now shown to be engaged in drum slot 23, while, to additionally underscore and illustrate that rotation has taken place, octagonal tool adapter chamber 17 is at a different angle compared to the angle it had been at in FIG. 10.

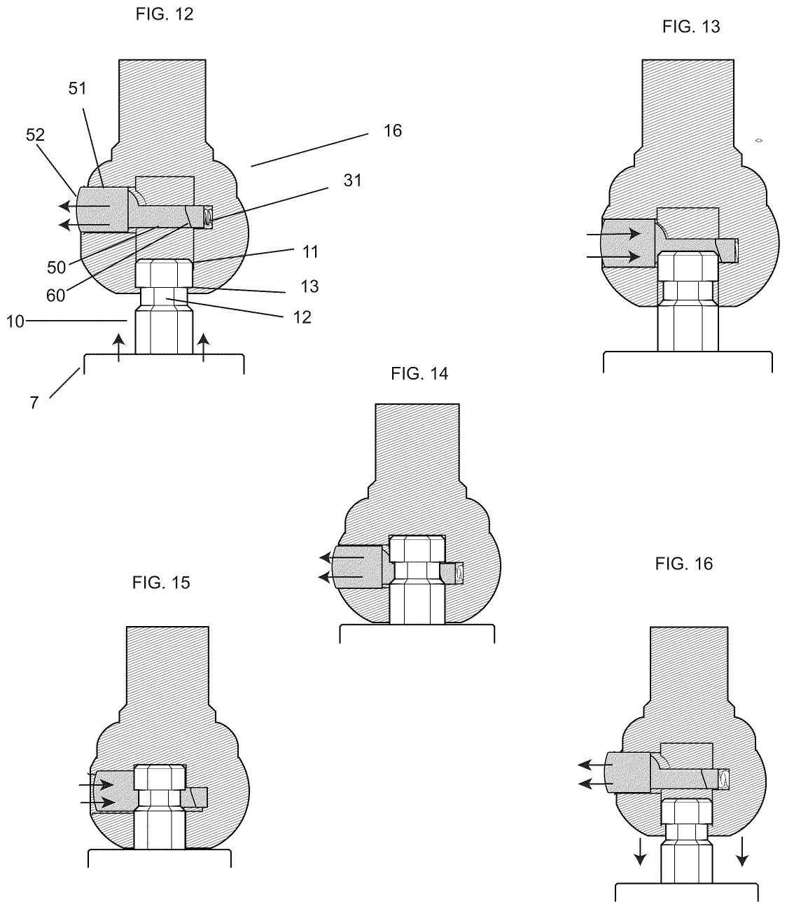

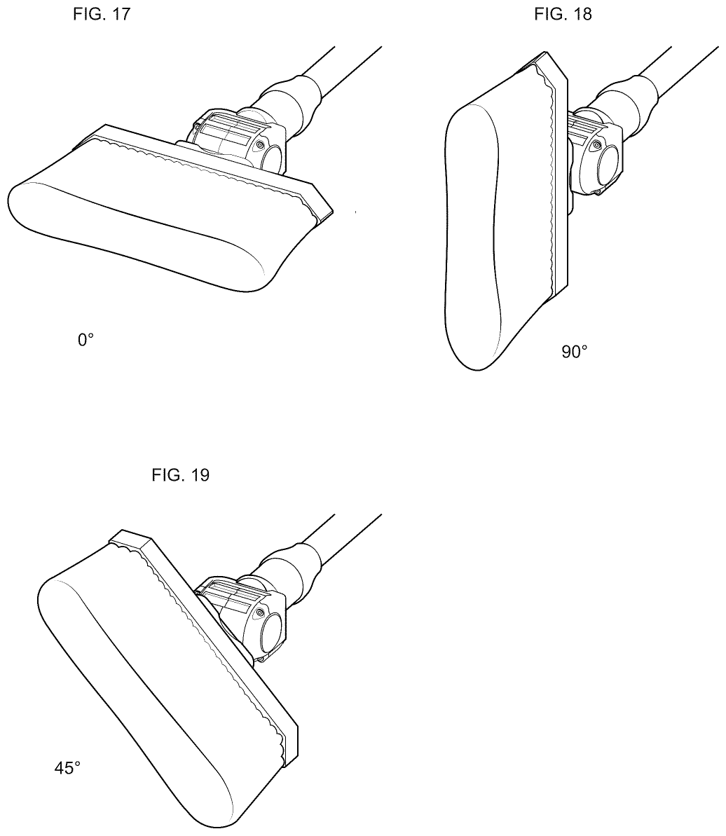

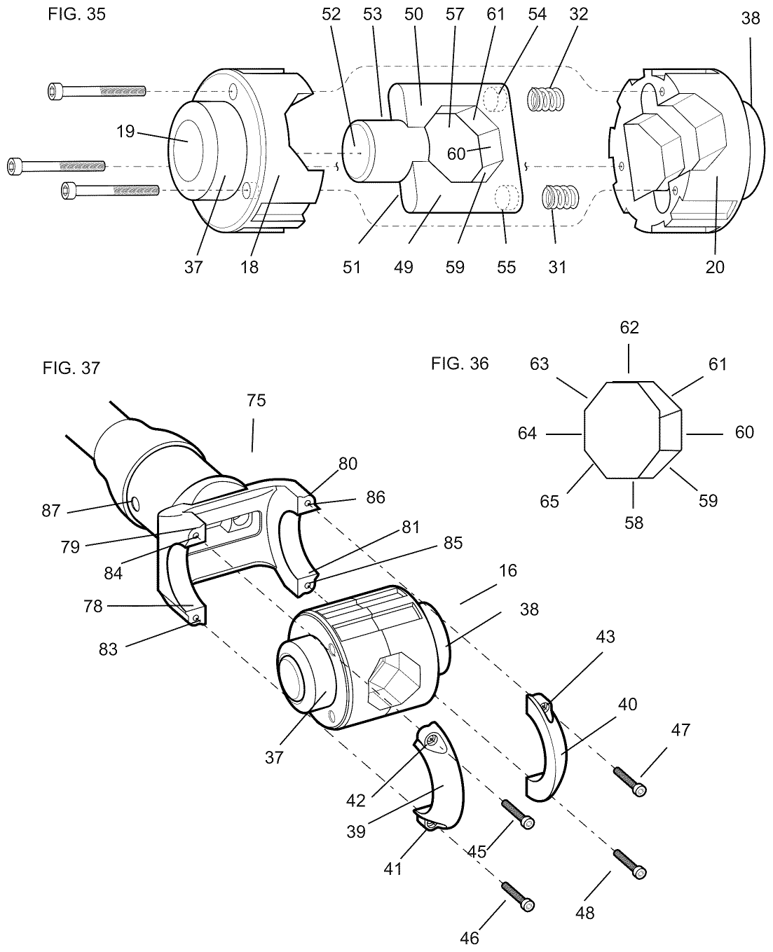

FIGS. 12-16 are cutaway views of drum assembly 16 that show five steps in the cycle of tool head 2-5 mounting process: FIG. 12 shows adapter 6 preparing to mount; FIG. 13; FIG. 14 shows adapter 6 is, owing to the interface of sloped surfaces, is able to slide tool lock 49 out of its locked position; FIG. 14 shows tool lock 49 engaged within the recess of adapter post notch 12; FIG. 15 shows tool lock 49 in its unlocked state which allows for tool head 2-5 release; and, FIG. 16 shows adapter 6 being released from octagonal tool adapter chamber 17. Refer also to FIG. 35 for an isolated, exploded view of drum assembly 16, and FIG. 36 for a visual accompaniment to the specific geometry of the inner surface of the tool lock octagonal adapter aperture 57.

FIG. 12 shows adapter 6 getting ready to mount to tool holder 1. The adapter 6 has already entered the octagonal tool adapter chamber 17 of drum assembly 16. Adapter post top ramped surface perimeter 11 (around the proximal end of tool adapter post 10) has not yet begun to index to the ramped surface of tool lock octagonal key faces 59-61. As such, the tool lock is in a locked position: the tool lock top surface 51 of tool lock octagonal key faces 59-61 are urged toward the center of the octagonal tool adapter chamber 17. Because only these three faces, 59-61, of faces 58-65 are inwardly sloped (refer to FIG. 41), they are, in this, their resting state, offset, on their proximal ends, within the octagonal tool adapter chamber 17, but inwardly slope toward their distal end such that, at this distal end, these faces 59-61 are tangent, and therefore not offset to the distal, transversely oriented surface of the octagonal tool adapter chamber 17.

FIG. 13 shows the point of engagement between the adapter post top ramped surface perimeter 11 and the ramped surfaces of tool lock octagonal key faces 59-61. Owing to the adapter post top ramped surface perimeter 11 and the ramped surfaces of tool lock octagonal key faces 59-61, adapter 6 can be pushed into the octagonal tool adapter chamber 17 as, by means of such urging, and such urging only, tool lock 49 is pushed, momentarily, to its unlocked state: the tool lock top surface 51 of tool lock octagonal key faces 59-61 are urged away from the center of the octagonal tool adapter chamber 17 such that the tool lock top surface 51 of tool lock octagonal key faces become flush with the interior wall of the octagonal tool adapter chamber 17.

FIG. 14 shows that tool lock 49 has moved into its locked position, thus securely locking the tool adapter 6. The locking of tool adapter 6 is achieved because the adapter post notch engaging ledge 12 is indexed by the tool lock top surface of tool lock octagonal key faces 59-61. It should be noted that tool adapter 6 is unable to rotate axially given that its octagonal geometry is conformal to the octagonal geometry of the octagonal tool adapter chamber 17 in which it is lodged, as depicted in illustration FIG. 14.

FIG. 15 shows that when pressure is applied to tool unlock button 52, as it emerges from the boundary of shoulder aperture 19 of cylindrical member 18 the ramped surfaces of tool lock octagonal key faces 59-61 slide out from under, and thereby disengage from under adapter post notch engaging ledge 13 of adapter post notch 12. While pressure is being applied to tool unlock button 52 with sufficient force to disengage adapter post notch engaging ledge 12 from tool lock octagonal key faces 59-61, it then becomes possible to dislodge tool adapter 6 from the octagonal tool adapter chamber 17 as shown in FIG. 16.

FIGS. 17-19 is a view that shows a broom tool head 2 mounted to drum assembly 16. Owing to the octagonal geometry of the adapter post 10, along with the octagonal tool adapter chamber 17 into which the adapter post 10 inserts, the broom tool head 2 can be mounted to drum assembly 16 in increments of 45° for eight positions around a 360° arc of rotation.

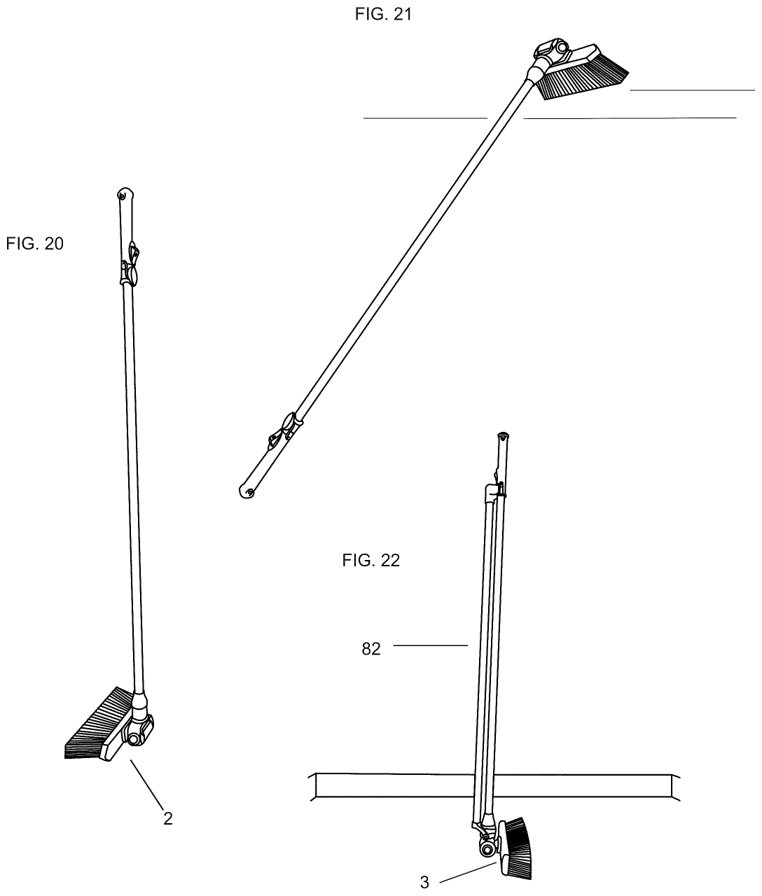

FIGS. 20-22 are views that show how the tool holder 1 can be angled with respect to the tool 2-5 that it is holding, and how the tool head can be mounted at a rotation of 45°.

FIG. 20 shows broom 2 self-standing which is made possible by dynamic angle adjustment which means that a dynamic adjustment can be performed without interrupting the flow of work. Self-standing is a feature of all tools held by the tool holder 1.

FIG. 21 shows how the broom 2 can be advantageously angled to clean the tops of surfaces which are above the user's head.

FIG. 22 shows the push broom tool head 3 coupled to the tool holder 1. Like the broom 2, it can self-stand, even with the secondary handle 82 attached to the joint secondary handle accessory dock 76 at the distal end of the tool holder 1 and attached at the proximal end to the magnetic accessory dock 113.

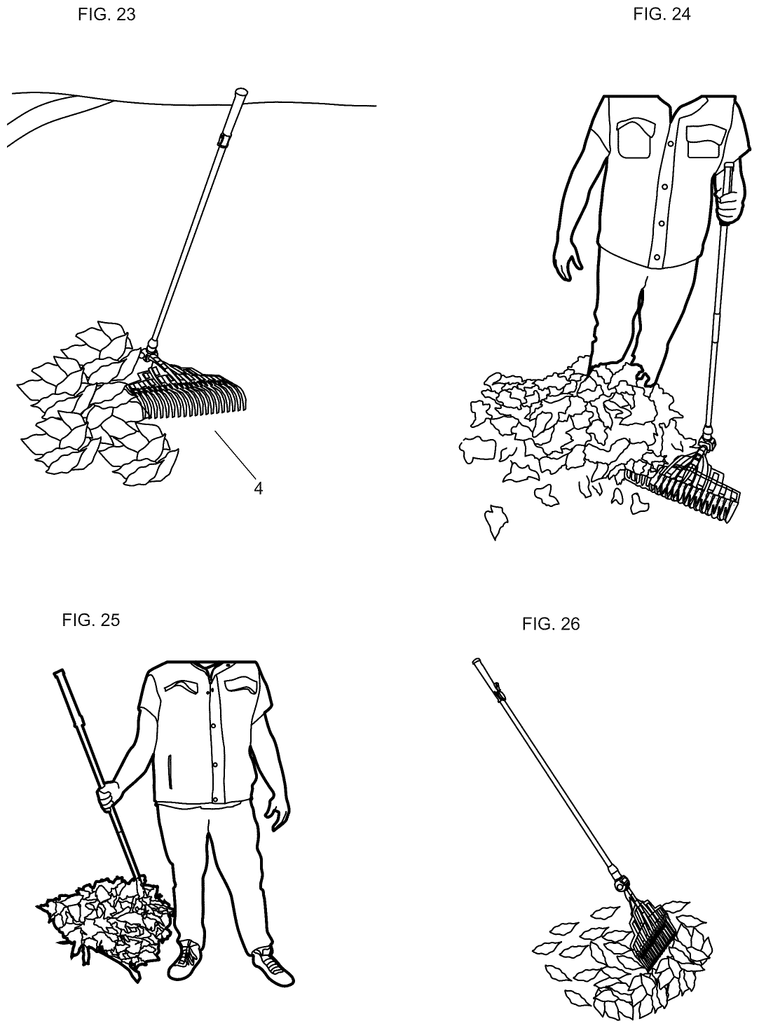

FIG. 23 shows the rake tool head 3 coupled to tool holder 1. In this view, the tool holder 1 is angled with relation to the rake tool head 4 at approximately 60° to allow the rake to self-stand.

FIG. 24 shows the rake tool head 4 at an approximately 90° angle in relation to the tool holder 1. In this position, the rake tool head 4 can serve as a surface upon which leaves, and light debris can be loaded without needing to use one's hands.

FIG. 25 shows the tool holder 1 angled forward approximately 30° from 90°. When the tool holder 1 is brought off the ground when it is so angled, the angle of the tool being held is angled upward, at an angle, as opposed to being coplanar with the ground or floor. The advantage is that the leaves fall toward the back of the rake head 4 and can therefore be held more securely than if the tool holder 1 were perpendicular to the rake head 4 such as it would be if it were at a 90°.

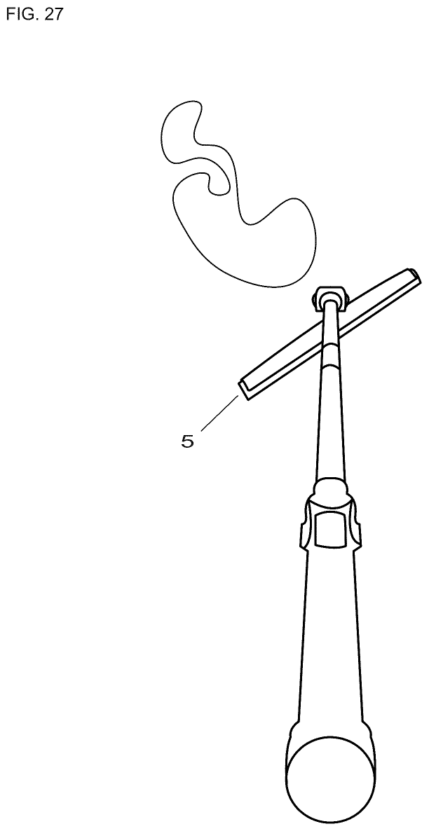

FIG. 26 shows that with the rake tool head 4 is continuous with tool holder 1, it looks and functions like any conventional rake.

FIG. 27 shows a squeegee tool head 5. In this view, the squeegee tool head 5 is mounted at an axially rotated 45° angle with respect to the tool holder 1, while the tool holder 1 is at an approximately 45° angle with respect to the horizontal plane of the surface above which it is situated. This illustration is meant to point out the advantage of being able to mount a tool head at this angle. Tool holder 1 can push the squeegee tool head 5 forward while the arm of the operator of the tool can remain aligned with the plane of the tool holder 1. Put another way, because the squeegee tool head 5 is so angled, the user can push on the handle without needing to angle the tool away from his or her body, or without needing to extend his or her arms.

For certain tasks performed by certain tools, having a tool head so angled is advantageous. A squeegee is often used to shunt liquid to one side of a surface as opposed to straight ahead. The same is also often true of a snow shovel where it might be desirable to push snow to one side or the other of the sidewalk.

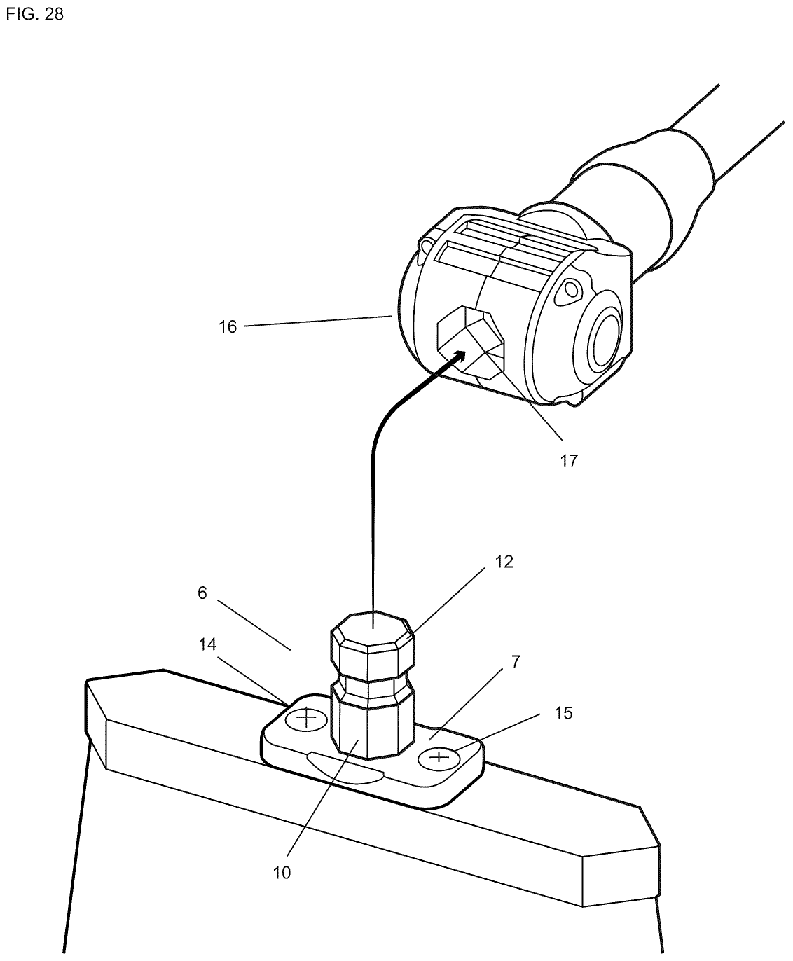

FIG. 28 is an assembly view that explicitly shows the octagonal geometry of adapter post 10 of broom tool head 2 couplable to the drum assembly 16 via the drum assembly 16 octagonal tool adapter chamber 17. Adapter 6 consists of an adapter base 7 which has a surface extending horizontally with respect to adapter post 10 and is congruent with the surface contours of the broom head 2 through which two apertures 8,9 exist on either side of adapter post 10.

On adapter base 7, there are two circular apertures 8,9 are meant to admit the passage of adapter screws 14,15 (see FIG. 39) to secure the adapter 6 to a particular tool head 2-5. FIGS. 17-19 are complementary to this assembly view as it shows, owing to the octagonal geometry of adapter post 10 and the matching geometry of the octagonal tool adapter chamber 17, that it is possible to mount tool heads 2-5 in increments of 45°.

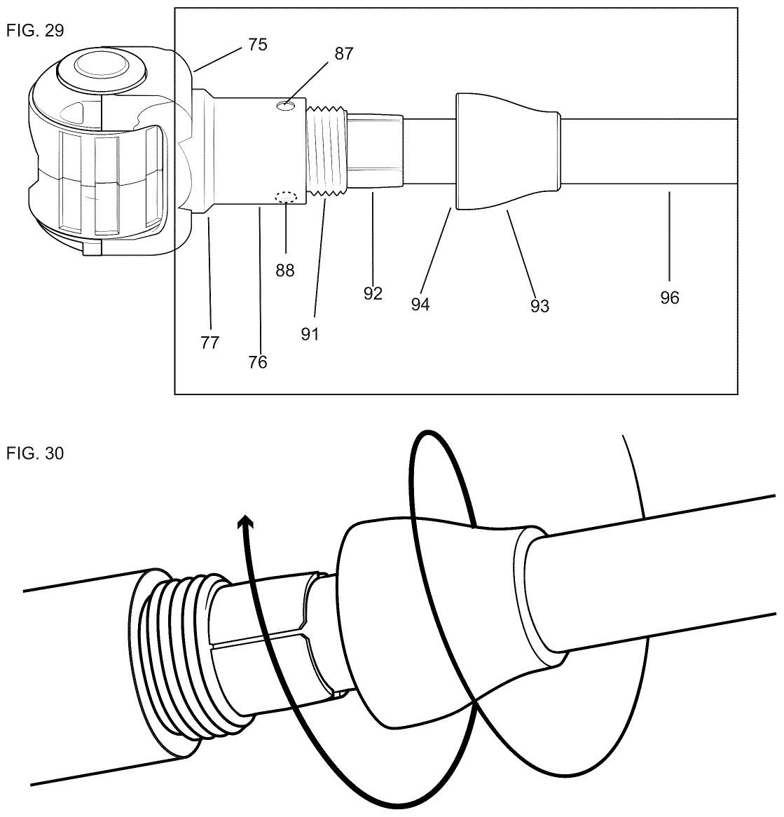

FIG. 30 is a detail view of what is shown in FIG. 29 callout demarcated by a rectangle surrounding the detail view in question. A threaded compression collar 93 is configured to mate with the threads 91 of joint 75 compression flanges 92 facilitating the axial compression of said flanges 92 upon rotation of the compression collar 93. This compression all the more secures the handle 96 within the joint 75 despite the fact that the handle 96 is also secured to the joint assembly 75 via joint/handle screws 89,90 which pass through joint screw apertures 87,88. It is recognized that this extra measure of securement is necessary given that screws tend to become loose over time, particularly in applications where variable and random forces from many angles are applied against the parts they are meant to fasten.

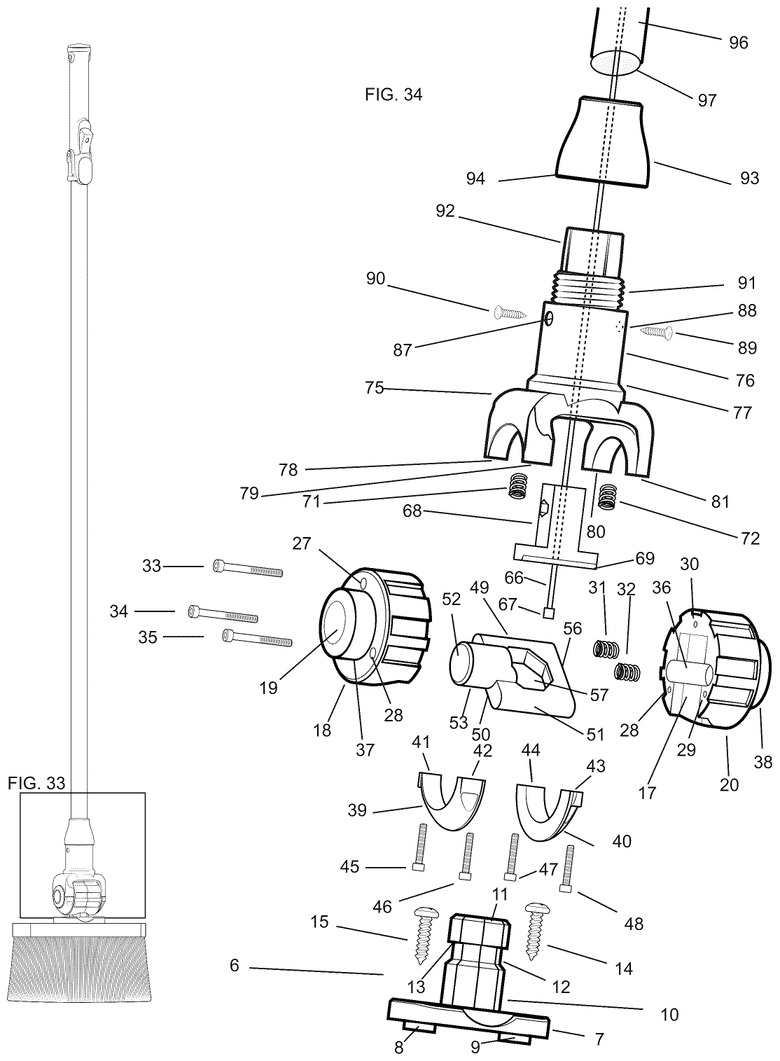

The distal end of the compression collar 94 (FIG. 33) is of such a diameter that it serves, along with joint accessory dock base 77, to form a recessed, cylindrical channel around which the collar of a secondary handle 88 may be securely mounted, and mounted in such a way that the movement and motion of the collar would be constrained to axial rotation only.

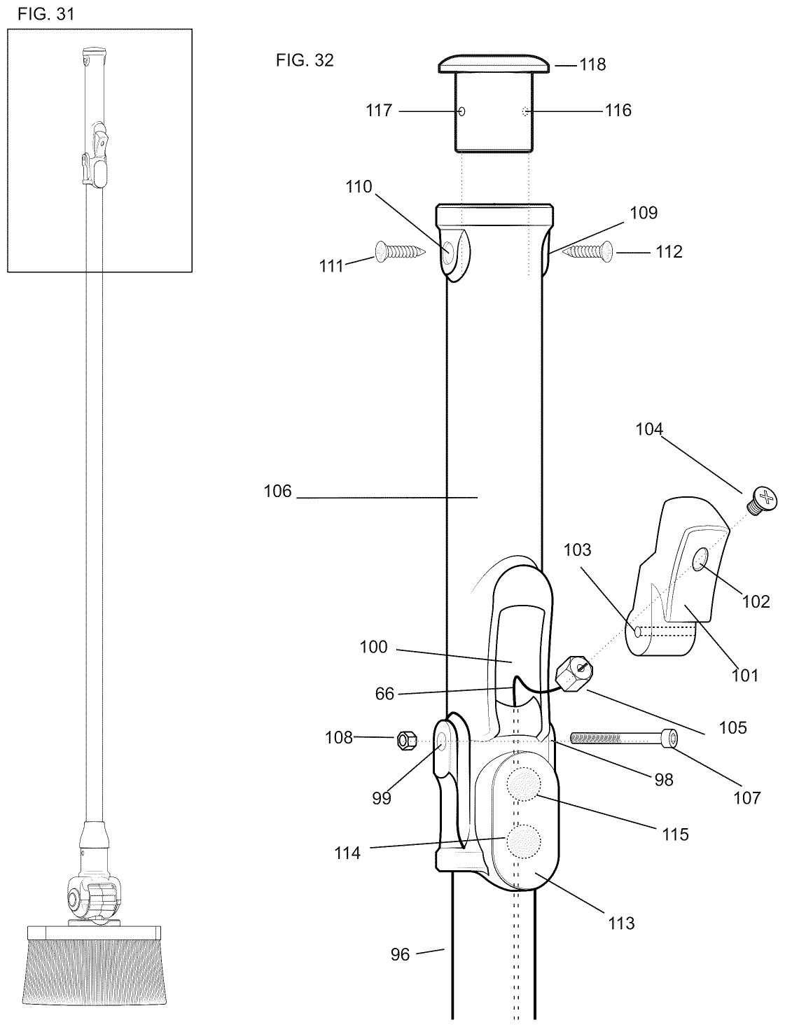

FIG. 32 is an exploded view of the rectangle-demarcated view of FIG. 31 callout. Handle 96 has at its proximal end, a casing 106 which encloses handle 96. Casing 106 is secured to handle 96, in this embodiment, by a bolt 107 which passes through aperture 98 in the casing 106, then through toggle bolt aperture 103 where bolt 107 serves as the pivot point for toggle 101. Bolt 107 then passes through casing aperture 99. Bolt 107 is fastened into place by nut 108. Handle 96 is further secured by screws 111,112 which pass through apertures 109,110 in handle casing, and by so doing, also secure end cap 119 as they also pass through end cap screw apertures 116,117.

Aperture 100 is a cavity that admits the secure stationing of toggle 101. Cable 66 threads through toggle nut 105 and is secured in place by toggle machine screw 104 which passes through toggle machine screw aperture 102.

Magnetic accessory dock 113 has raised sides and forms the shape of a rectangle with rounded ends. The magnetic accessory dock 113 encloses magnets 114,115. Upon the magnetic accessory dock, accessories of one variety or another can be docked. Such accessories may include other tool heads, a dustpan, or the proximal end of a secondary handle 82 which, at its distal end, can be secured to joint accessory dock 76 (see FIG. 30).

FIG. 34 is an exploded view of the rectangle-demarcated view of FIG. 33 callout. Specifically, FIG. 39 shows the assembly of the distal end of tool holder 1. A first semi-cylindrical member 18 and a second cylindrical member 20 are configured to mate along their longitudinal edges, forming a composite cylindrical assembly 16. The members are secured together by a plurality of threaded fasteners 33-35 extending through aligned apertures in the respective members 28-30. When the first and second cylindrical members 18,20 are secured by threaded fasteners 33-35, two cavities, tool lock recess 36 and, octagonal tool adapter chamber 17 are formed, with each cavity oriented with respect to the other perpendicularly, and each with a distinct and separate purpose.

The tool lock 49 is received within the tool lock recess 36 and is restricted to only linear movement along an axis perpendicular to the handle 96. Springs 31 and 32, are located between the tool lock spring-tangent end 56 and the interior surface of the tool lock recess 36, the geometry of which is a negative space in the shape of the part of the tool lock 49 described as the tool lock spring-tangent end 56 of cylindrical member 20. Springs 31,32 urge the tool lock 49 towards its locked position. In this locked position, the tool lock octagonal adapter aperture 57 of the tool lock 49 is tangent with the distal surface of the octagonal tool adapter chamber 17. From the tool lock bottom surface 50 with which the tool lock octagonal adapter aperture 57 is continuous, tool lock octagonal key faces 59-61 of the tool lock 49 slope upward (toward the proximal end of tool holder 1) and inward toward the tool lock top surface 51 (with which it is continuous) within the octagonal tool adapter chamber 17.

FIGS. 12-16 show that, as a result, tool lock octagonal key faces 59-61 of the tool lock 49, sloped inwardly, serve as a ramped offset within the octagonal tool adapter chamber 17, and, owing to this offset, the tool lock 49 is in a locked position. Further, owing to this offset, adapter post 10 of adapter 6 can be urged into the octagonal tool adapter chamber 17, as by means of such urging, the tool lock 49 will be urged toward the tool lock recess 36 against the urging force of springs 31, 32 until sides of the octagonally shaped adapter post notch 11 are coplanar with tool lock octagonal key faces 59-61 of tool lock 49. When the adapter post notch 12 is coplanar with tool lock 49, springs 31, 32 urge tool lock 49 away from tool lock recess 36, bringing sides 59-61 of the tool lock octagonal key faces 59-61 to engage within the recess of adapter post notch 12.

FIG. 34 further shows the inner surface of semi-circular drum clamp 39, conformal to shoulder 37 of cylindrical member 18 of drum assembly 16. Semi-circular drum clamp 39 is fastened by screws 45,46 to the joint screw wells 83,84 (shown in FIG. 37) on joint posts 78,79 after screws 45,46 first pass through semi-circular screw apertures 41,42 of semi-circular drum clamp 39.

FIG. 34 further shows the inner surface of semi-circular drum clamp 40, is conformal to shoulder 38 of cylindrical member 20 of drum assembly 16. Semi-circular drum clamp 40 is fastened by screws 47,48 to the joint screw wells 85,86 (shown in FIG. 37) on joint posts 80,81 after screws 47,48 first pass through semi-circular screw apertures 43,44 of semi-circular drum clamp 40.

A transversely oriented cylindrical cavity is formed when drum clamps 39,40 are fastened to joint posts 78-81 into which drum assembly 16 can be securely mounted along its transverse axis. So mounted, the drum assembly can freely rotate axially around its transverse axis when such rotation is not prevented by engagement of brake foot tooth 69 into one of the slots 21-27 that exist on the exterior surface of drum assembly 16.

FIG. 35 is an exploded view of the drum assembly used as a reference to make it clearer than it might have been in other views, how the parts of the drum assembly go together. This view is included for completeness, clarity, and reference.

FIG. 36 is an isolated view of the tool lock octagonal adapter aperture 57. This view is included to add clarity as to how tool lock octagonal key faces 59-61 of the tool lock octagonal adapter aperture 57 are ramped.

FIG. 37 is an isolated, exploded view of joint 75, with the assembled drum 16 included. It is intended for completeness, clarity, and reference.

FIG. 38 shows the threaded inner surface of compression collar 93.

FIG. 39 shows the spring wells 73,74 of the brake foot, the brake foot cable lumen and the brake foot springs 71,72. This view is included for completeness, clarity, and reference.

1: An adjustable tool holder comprising:
a handle;
a joint assembly connected to the handle;
a drum assembly within the joint assembly;
a tool head adapter configured to be mounted to the drum assembly at multiple angular positions;
a locking mechanism within the drum assembly that secures the tool head adapter in one of multiple fixed angular positions;
a dynamic adjustment mechanism allowing the angle between the handle and the tool head to be changed in a sweeping arc of up to 270° without interrupting use.

2: The tool holder of claim 1, wherein the tool head adapter comprises an octagonal post and the drum assembly comprises an octagonal tool adapter chamber, allowing the tool head adapter to be mounted in 45° increments around a 360° axis.

3: The tool holder of claim 1, wherein the dynamic adjustment mechanism comprises a brake foot and a cable, where the brake foot is disengaged by pulling the cable, allowing the drum assembly to rotate relative to the handle.

4: The tool holder of claim 1, wherein the locking mechanism comprises a tool lock with ramped surfaces that engage with a notch in the tool head adapter to secure the tool head in place.

5: The tool holder of claim 1, further comprising a compression collar on the joint assembly that reinforces the connection between the handle and the joint assembly.

6: The tool holder of claim 1, wherein the tool head adapter can be quickly mounted and detached by pushing the adapter into the drum assembly, which automatically locks the tool head in place.

7: The tool holder of claim 1, wherein the dynamic adjustment mechanism allows the tool holder to self-stand when the tool head is mounted.

8: The tool holder of claim 1, wherein the dynamic adjustment mechanism includes a toggle that, when depressed, disengages the locking mechanism and allows the drum assembly to rotate.

9: The tool holder of claim 1, further comprising an accessory mounting dock on the joint assembly for attaching additional accessories, such as a secondary handle.

10: The tool holder of claim 1, wherein the handle casing includes a magnetic accessory dock for securing accessories like a dustpan.

11: The tool holder of claim 1, wherein the drum assembly comprises multiple slots on its outer surface that engage with the brake foot to secure the tool head in fixed angular positions.

12: The tool holder of claim 1, wherein the locking mechanism is spring biased to automatically lock the tool head adapter when it is inserted into the drum assembly.

13: The tool holder of claim 1, further comprising an end cap on the handle casing with a toggle mechanism for activating the dynamic adjustment mechanism.

14: The tool holder of claim 1, wherein the brake foot comprises a tooth that engages with the slots on the outer surface of the drum assembly to lock the tool head in place.

15: The tool holder of claim 1, wherein the handle is secured to the joint assembly by screws and further reinforced by the compression collar to prevent loosening over time.

16: The tool holder of claim 1, wherein the octagonal tool adapter chamber and tool head adapter allow the tool head to be mounted at an angle, enabling ergonomic use for tasks such as sweeping or raking.

17: The tool holder of claim 1, wherein the dynamic adjustment mechanism allows the tool holder to adapt to various tool heads, including brooms, rakes, debris pans, shovels, and squeegees, providing versatility for different tasks.

18: The tool holder of claim 1, wherein the cable of the dynamic adjustment mechanism runs through a lumen in the handle, reducing weight and improving maneuverability compared to rod-based mechanisms.
